(19) United States
(12) Patent Application Publication
(10) Pub. No.: US 2022/0171035 A1
(43) Pub. Date: Jun. 2, 2022

(54) OPTICAL INTERFEROMETRIC LIDAR SYSTEM TO CONTROL MAIN MEASUREMENT RANGE USING ACTIVE SELECTION OF REFERENCE OPTICAL PATH LENGTH

(71) Applicant: Pusan National University Industry-University Cooperation Foundation, Busan (KR)

(72) Inventors: Chang-Seok KIM, Busan (KR); Seongjin BAK, Busan (KR); Hansol JANG, Busan (KR); Chang Hyun PARK, Busan (KR)

(73) Assignee: Pusan National University Industry-University Cooperation Foundation, Busan (KR)

(21) Appl. No.: 17/538,502

(22) Filed: Nov. 30, 2021

(30) Foreign Application Priority Data
Nov. 30, 2020 (KR) 10-2020-0165004

(51) Int. Cl. G01S 7/4861; G05D 1/02; G01S 7/481; G01N 21/45

(52) U.S. Cl. CPC G01S 7/4861; G05D 1/024; G01N 2021/458; G01N 21/45; G01S 7/4816

(57) ABSTRACT

An optical interferometric LiDAR system to control the main measurement range using active selection of a reference optical path length according to an absolute position of an object to be measured, including: a laser source unit configured to emit light having a variable wavelength; a light dividing unit configured to divide the light into a variable reference arm and a measurement arm; a variable reference arm having a structure for selecting an optical path length of a reference arm; a measurement arm configured to propagate light and receive light reflected from a target object; and a light detecting unit configured to detect an optical signal generated as light passing through the variable reference arm and light passing through the measurement arm cause optical interference.

### ACKNOWLEDGEMENT

This work was supported by a National Research Foundation of Korea (NRF) grant funded by the Korea government (Ministry of Science and ICT (MSIT)) (No. NRF-2021R1A5A1032937), a Commercialization Promotion Agency for R&D Outcomes (COMPA) funded by the Ministry of Science and ICT (MSIT) (1711123345), and a Korea Medical Device Development Fund grant funded by the Korea government (the Ministry of Science and ICT, the Ministry of Trade, Industry and Energy, the Ministry of Health and Welfare, and the Ministry of Food and Drug Safety) (202011C13, KMDF_PR_20200901_0055).

### CROSS-REFERENCE TO RELATED APPLICATION

This application claims priority to Korean Patent Application No. 10-2020-0165004 (filed on Nov. 30, 2020), which is hereby incorporated by reference in its entirety.

### BACKGROUND

The present disclosure relates to a light detection and ranging (LiDAR) system, and more specifically, to an optical interferometric LiDAR system to control the main measurement range using active selection of a reference optical path length according to an absolute position of an object to be measured.

In general, an optical interferometric LiDAR system uses a wavelength-swept laser (or frequency-swept laser) as a laser source unit and basically includes an optical interferometer including a light dividing unit, a reference arm, a measurement arm, and a light detection unit.

Here, the light output from the laser source unit is divided while passing through the light dividing unit and is output to the reference arm and the measurement arm, respectively.

Each output light is reflected from a reference reflector at the reference arm, is reflected from a target object at the measurement arm, and returns to the light dividing unit.

An optical interference signal is generated due to a difference in distance between the respective optical paths.

The optical interference signal is output as an electrical signal through the light detection unit, and relative distance difference information of the target object can be converted to be obtained through fast-Fourier transformation (FFT) of the electrical signal.

In this case, the intensity of a relative distance difference conversion signal indicating the relative distance difference information between the reference reflector and the target object is strongest when there is no difference in the relative optical path distance difference between the reference reflector and the target object, and decreases proportionally as the difference in the relative optical path distance increases, and decreases less than half of maximum intensity when the difference in the relative optical path distance over than a coherence length of the laser source unit.

In addition, relative distance difference measurement can be accurately measured only when the intensity of the relative distance conversion signal is greater than a specific value to be stronger than noise.

In the optical interferometric LiDAR system based on the optical interferometer of the conventional technique, since an optical path length of the reference reflector is fixed in the reference arm, the relative distance conversion signal may be easily converted into an absolute position conversion signal from the fixed length of the reference arm.

However, due to a constraint that a intensity distribution of the relative distance difference conversion signal and intensity distribution of the absolute position conversion signal are always identical, in the case of a target object in a position corresponding to the short distance difference as the distance of the reference reflector, a relative distance and an absolute position may be accurately measured through a conversion signal having a high intensity, on the other hand, in the case of a target object in a position corresponding to a significantly distance different from the reference reflector, a conversion signal having a low intensity, and therefore, it is difficult to measure a relative distance difference and an absolute position.

In particular, when a position and a speed of an object to be measured by the optical interferometric LiDAR system change, such as autonomous vehicles, ships, and drones, it is necessary to optimize a measurement range of an absolute position by adjusting a relative distance difference measurement range actively to suit each changing state to maximize to obtain a conversion signal having a higher intensity.

In addition, even when a laser source unit with a sufficient coherence length is used, it is difficult to obtain a high intensity of conversion signal due to absorption and scattering loss caused by long distance difference from a target object and absorption and scattering loss additionally occurring in an atmospheric measurement environment (rain, fog, humidity, dust conditions, etc.).

Accordingly, there is a need for the develop a new technology capable of optimizing a measurement range of an absolute position by actively adjusting the main measurement range that maximizes the intensity of an optical interference signal.

### RELATED ART DOCUMENT

### Patent Document

(Patent document 1) Korean Patent Laid-open Publication No. 10-2020-0049390
(Patent document 2) Korean Patent Laid-open Publication No. 10-2019-0014314
(Patent document 3) Korean Patent Registration No. 10-1547940

### SUMMARY

In view of the above, the present disclosure provides an optical interferometric LiDAR system to control the main measurement range using an active selection of a reference optical path length according to an absolute position of an object to be measured.

The present disclosure provides an optical interferometric LiDAR system to control the main measurement range using active selection of a reference optical path length, capable of optimizing a measurement range of an absolute position by actively adjusting the main measurement range optimizing a intensity of an optical interference signal.

The present disclosure provides an optical interferometric LiDAR system to control the main measurement range using an active selection of a reference optical path length, capable of actively selecting the main measurement range of a target object optical path position corresponding to a reference reflector optical path distance using a variable reference arm able to actively change an optical path length.

The present disclosure provides an optical interferometric LiDAR system to control the main measurement range using an active selection of a reference optical path length, capable of changing an optical path length of a reference arm using selection of each length of the reference arm, adjusting the main measurement range in which a maximum optical interference intensity is detected, and actively changing the main measurement range, thereby solving a problem in which an existing optical interferometric LiDAR system is limited to a coherence length of a light source to limit a measurement range.

The present disclosure provides an optical interferometric LiDAR system to control the main measurement range using active selection of a reference optical path length, capable of implementing an optical interferometric LiDAR system for actively adjusting the main measurement range by maximizing an optical interference signal reduced by an external environment in a desired distance section even when a light source having a sufficient coherence length is used.

The present disclosure provides an optical interferometric LiDAR system to control the main measurement range using active selection of a reference optical path length, capable of measuring by actively selecting a major relative distance measurement range corresponding to a changed reference arm optical path length and an absolute position measurement range through a method of variably selecting and changing an optical path length of a reference arm.

Other objects of the present disclosure are not limited to the above-mentioned objects, and other objects not mentioned will be clearly understood by those skilled in the art from the following description.

The present disclosure provides an optical interferometric LiDAR system to control the main measurement range using active selection of a reference optical path length, including: a laser source unit configured to emit light having a variable wavelength; a light dividing unit configured to divide the light into a variable reference arm and a measurement arm; a variable reference arm having a structure for selecting an optical path length of a reference arm; a measurement arm configured to propagate light and receive light reflected from a target object; and a light detecting unit configured to detect an optical signal generated as light passing through the variable reference arm and light passing through the measurement arm cause optical interference, wherein the main measurement range in which a relative maximum optical interference intensity is adjusted according to active selection of an optical path length of the reference arm varied at the variable reference arm.

Relative distance difference information based on a time of the target object, relative direction information of the target object, or relative speed information of the target object may be obtained by repeatedly comparing optical interference intensity of each of a plurality of optical signals detected by the light detecting unit according to time by adjusting the variable reference arm according to time.

The main measurement range in which a relative maximum optical interference intensity is detected may be adjusted according to active selection of an optical path length of the reference arm varied at the variable reference arm, using a method of obtaining relative speed information of the obtained target object.

The main measurement range in which a relative maximum optical interference intensity is detected may be adjusted according to active selection of an optical path length of the reference arm varied at the variable reference arm, using a method of relatively comparing a result of comparing the optical interference intensity of each of a plurality of optical signals detected by the light detecting unit according to time by adjusting the variable reference arm according to time and a result of comparing optical interference intensity according to optical path lengths based on absorption loss and scattering loss occurring due to optical propagation between the measurement arm and the target object and optical reflection atmospheric environment.

The main measurement range in which a relative maximum optical interference intensity is detected may be adjusted according to active selection of an optical path length of the reference arm varied at the variable reference arm, as an optical interference signal generated through a Michelson interferometer is detected in the light dividing unit based on light varied and propagated through selection of one of a plurality of different optical path lengths at the variable reference arm and then returned after being reflected by a reference reflector and light returned after being reflected from the target object at the measurement arm.

A Mach-Zehnder interferometer including a light dividing interference unit may be provided, and the main measurement range in which a relative maximum optical interference intensity is detected may be adjusted according to active selection of an optical path length of the reference arm varied at the variable reference arm, as an optical interference signal generated through the Mach-Zehnder interferometer including the light dividing interference unit is detected in the light detecting unit based on light varied and propagated through selection of one of a plurality of different optical path lengths at the variable reference arm and then moving after being transmitted to the light dividing interference unit in a position different from the light dividing unit and light transmitted through the light dividing unit and a light circulation unit to move to the measurement arm and moving after being reflected from the target object at the measurement arm and transmitted to the light circulation unit and the light dividing interference unit.

The variable reference arm may include an optical path selection switch, a plurality of optical fibers having different optical path lengths, and a reference reflector at the end of each of the plurality of optical fibers, and the main measurement range in which a relative maximum optical interference intensity is detected may be adjusted according to active selection of an optical path length of the reference arm varied at the variable reference arm, using a method of selecting a specific optical fiber as a reflective type as the optical path selection switch is reacted by a manual command, an automatic command based on position information of the target object, or an automatic command based on a distance speed information of the target object.

The variable reference arm may include an optical path selection switch at an entrance, a plurality of optical fibers having different optical path lengths, and an optical path selection switch at an exit, and the main measurement range in which a relative maximum optical interference intensity is detected may be adjusted according to active selection of an optical path length of the reference arm varied at the variable reference arm, using a method of selecting a specific optical fiber as a transmission type as the two optical path selection switches are reacted by a manual command, an automatic command based on position information of the target object, or an automatic command based on a distance speed information of the target object.

The variable reference arm may include a wavelength division multiplexer (WDM), optical fibers having different optical path lengths by wavelength regions divided by the WDM, and a reference reflector at the end of each optical fiber, and the main measurement range in which a relative maximum optical interference intensity is detected may be adjusted according to active selection of an optical path length of the reference arm corresponding to a specific wavelength region at the variable reference arm, using a method of comparing and selecting optical interference intensity of a plurality of optical signals detected according to wavelengths by the light detecting unit.

The variable reference arm may include one or more of a partial reflector having a fiber Bragg grating structure and a liquid crystal polarization adjusting device, and the main measurement range in which a relative maximum optical interference intensity is detected may be adjusted according to active selection of an optical path length of the reference arm corresponding to a specific polarization state at the variable reference arm, using a method in which there are a plurality of different optical path lengths and light of a specific polarization state is selected to correspond to only a specific optical path length according to an operation of the polarization adjusting device.

The present disclosure also provides an optical interferometric LiDAR system to control the main measurement range using active selection of a reference optical path length, including: a laser source unit configured to emit light having a variable wavelength; a light dividing unit configured to divide the light into a reference arm and a measurement arm; a multi-light dividing unit configured to divide light of the reference arm divided by the light dividing unit to a plurality of multi-reference arms; a multi-reference arm configured to allow each light divided by the multi-light dividing unit to go through different optical path lengths; a measurement arm configured to propagate light and receive light reflected from a target object; and a multi-light detecting unit configured to detect an optical signal generated as a plurality of lights passing through the light dividing unit and the multi-light dividing unit and light passing through the measurement arm cause a plurality of light interferences, wherein the main measurement range in which a relative maximum optical interference intensity is detected is adjusted according to active selection of an optical path length of the reference arm varied at the variable reference arm, using a method of selecting optical interference intensity of a plurality of optical signals detected by the multi-light detecting unit.

The laser source unit may include a multi-wavelength laser light source units configured to emit light varied by multiple output wavelengths simultaneously, the multi-light dividing unit includes a per-wavelength multi-light dividing unit configured to perform multi-light division for each wavelength according to a wavelength region varied by multiple output wavelengths. The main measurement range in which a relative maximum optical interference intensity is detected may be adjusted according to active selection of an optical path length of the reference arm varied at the variable reference arm, using a method of comparing and selecting optical interference intensity of a plurality of optical signals obtained by simultaneously detecting a plurality of lights through different optical path lengths by the wavelength regions by the multi-light detecting unit.

Relative distance difference information based on a time of the target object, relative direction information of the target object, or relative speed information of the target object may be obtained by repeatedly comparing optical interference intensity of each of a plurality of optical signals detected by the multi-light detecting unit according to different optical path lengths.

The main measurement range in which a relative maximum optical interference intensity is detected may be adjusted according to active selection of an optical path length of the reference arm varied at the variable reference arm, using a method of obtaining relative speed information of the obtained target object.

The main measurement range in which a relative maximum optical interference intensity is detected may be adjusted according to active selection of an optical path length of the reference arm varied at the variable reference arm, using a method of relatively comparing a result of comparing the optical interference intensity of each of a plurality of optical signals detected by the multi-light detecting unit according to different optical path lengths and a result of comparing optical interference intensities according to optical path lengths based on absorption loss and scattering loss occurring due to optical propagation between the measurement arm and the target object and optical reflection atmospheric environment.

As described above, the optical interferometric LiDAR system to control the main measurement range using active selection of a reference optical path length according to the present disclosure has the following effects.

First, an optical interferometric LiDAR system to control the main measurement range using active selection of a reference optical path length according to an absolute position of an object to be measured is provided.

Second, it is possible to optimize a measurement range of an absolute position by actively adjusting the main measurement range optimizing a intensity of an optical interference signal.

Third, it is possible to actively select the main measurement range of a target object optical path position corresponding to a reference reflector optical path distance using a variable reference arm able to change an optical path length actively.

Fourth, an optical path length of a reference arm is changed using selection of each length of the reference arm, the main measurement range in which a maximum optical interference intensity is detected is adjusted, and the main measurement range is actively changed, thereby solving a problem in which an existing optical interferometric LiDAR system is limited to a coherence length of a light source to limit a measurement range.

Fifth, it is possible to implement an optical interferometric LiDAR system for to actively adjust the main measurement range by maximizing an optical interference signal reduced by an external environment in a desired distance section even when a light source having a sufficient coherence length is used.

Sixth, it is possible to perform measurement by actively selecting a major relative distance measurement range corresponding to a changed reference arm optical path length and an absolute position measurement range through a method of variably selecting and changing an optical path length of a reference arm.

### BRIEF DESCRIPTION OF THE DRAWINGS

FIG. 1 is a basic configuration diagram of an optical interferometric LiDAR system to control the main measurement range using active selection of a reference optical path length.

FIG. 2 is a configuration diagram illustrating the main measurement range selectively changed according to a change in an optical path position of a variable reference arm and intensity of a position conversion signal detected by a light detecting unit.

FIG. 3 is a configuration diagram of a Michelson interferometer-based LiDAR system.

FIG. 4 is a configuration diagram of a Mach-Zehnder interferometer-based LiDAR system.

FIG. 5 is a configuration diagram showing an example of a reflective variable reference arm;

FIG. 6 is a configuration diagram showing an example of a transmissive variable reference arm

FIG. 7 is a configuration diagram of a LiDAR system having a 1×N wavelength division multiplexer (WDM)

FIG. 8 is a block diagram illustrating a process in which the main measurement range is selected based on an interference signal for each wavelength region according to a position of a target object and a result of fast Fourier transform;

FIG. 9 is a configuration diagram illustrating an example in which the number of reference arms simultaneously used for measurement is divided by N using 1×N light dividing units.

FIG. 10 is a configuration diagram illustrating an example in which the number of reference arms used simultaneously for measurement is divided by N using 1×N WDMs.

FIG. 11 is a block diagram showing FFT intensity over FFT frequency of interference signals according to positions of a target object.

### DETAILED DESCRIPTION

Hereinafter, an embodiment of an optical interferometric LiDAR system to control the main measurement range using active selection of a reference optical path length according to the present disclosure will be described in detail as follows.

Features and advantages of the optical interferometric LiDAR system to control the main measurement range using active selection of a reference optical path length according to the present disclosure will become apparent through the detailed description of each embodiment below.

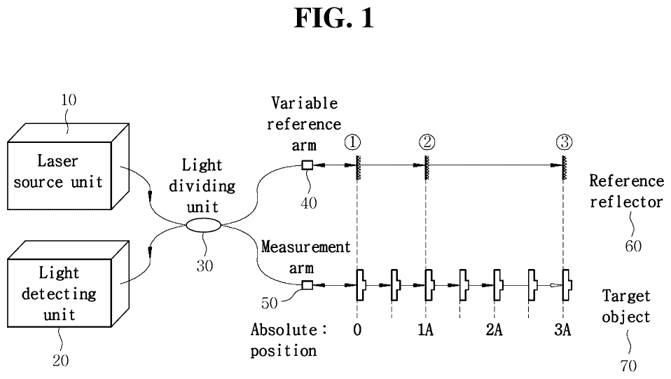

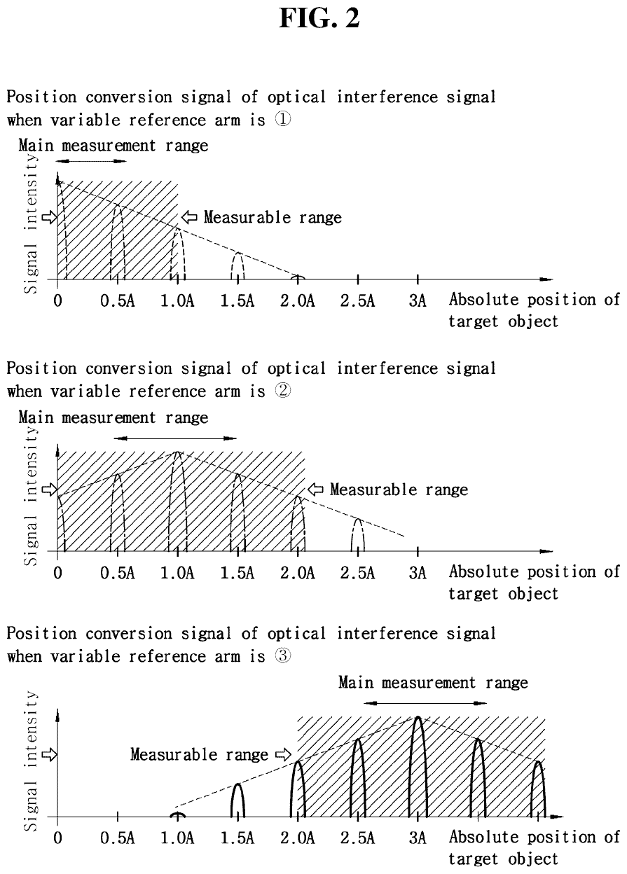

FIG. 1 is a basic configuration diagram of an optical interferometric LiDAR system to control the main measurement range using active selection of a reference optical path length, and FIG. 2 is a configuration diagram illustrating the main measurement range selectively changed according to a change in an optical path position of a variable reference arm and intensity of a position conversion signal detected by a light detecting unit.

The optical interferometric LiDAR system to control the main measurement range using active selection of a reference optical path length according to the present disclosure performs measurement by actively selecting the main relative distance measurement range corresponding to a changed reference arm optical path length and an absolute position measurement range through a method of changing by variably selecting an optical path length of a fixed reference arm used in the optical interferometer.

Here, an optical path of a free space corresponding to a position of a target object of a measurement arm should consider a refractive index of air at an actual physical distance, and an optical path of an optical fiber space corresponding to a position of a reference reflector of a variable reference arm should consider a refractive index of glass in a physical length of an optical fiber. This is because, in order to maximize optical interference between the measurement arm and the variable reference arm, a relative optical path distance difference between the reference reflector considering the refractive index of each medium and the target object should be minimized.

As shown in FIG. 1, the optical interferometric LiDAR system to control the main measurement range using active selection of a reference optical path length according to the present disclosure includes a laser source unit 10, a light detecting unit 20, a light dividing unit 30, a variable reference arm 40, a measurement arm 50, a reference reflector 60, and a target object 70.

A basic structure of the optical interferometric LiDAR system to control the main measurement range using active selection of a reference optical path length according to the present disclosure includes the laser source unit 10 emitting light having a variable wavelength, a light dividing unit 30 dividing the light into the variable reference arm 40 and the measurement arm 50, the variable reference arm 40 having a structure for selecting an optical path length of the reference arm, the measurement arm 50 propagating light and receiving light reflected from the target object, and the light detecting unit 20 for detecting an optical signal generated when the light passing through the variable reference arm 40 and the light passing through the measurement arm 50 cause optical interference.

Here, in a case in which a position of the variable reference arm 40 is \textcircled{1}, \textcircled{2}, \textcircled{3}, an absolute position of the target object 70 is 0 A˜3.0 A, a measurable range and the main measurement range according to the position of the variable reference arm is as follows.

FIG. 2 shows a measurable range and the main measurement range according to the position of the variable reference arm.

When the position of the variable reference arm is located at \textcircled{1}, a range of the absolute position of the target object within the measurable measurement arm is limited to 1 A or less. The reason that the measurable range is limited is because it is assumed that a coherence length of the light generated by the laser source unit is 1 A and intensity of a conversion signal disappears so that the conversion signal cannot be distinguished by noise when a distance difference greater than the coherence length occurs.

If the position of the variable reference arm is located at \textcircled{2}, the range of the absolute position of the target object within the measurable measurement arm is changed to increase twice as much from 0 to 2 A, an object at a relatively greater distance than when the variable reference arm is located at \textcircled{1} may be measured, and the main measurement range moves to a longer distance region. In this case, the measurable range is also limited because it is assumed that the coherence length of the light generated by the laser source unit is limited to a specific distance.

If the position of the variable reference arm is located at \textcircled{3}, the absolute position of the target object within the measurable measurement arm is defined as 2 A to 4 A, and an object at a relatively greater distance than when the variable reference arm is at \textcircled{2} may be measured. In this case, the measurable range is also limited because it is assumed that the coherence length of the light generated from the laser source unit is limited to a specific distance.

As such, as the variable reference arm is used, the main measurement range having high intensity of the relative distance conversion signal is changed, and it is possible to implement an optical interferometric LiDAR system that may actively select the corresponding absolute position measurement range.

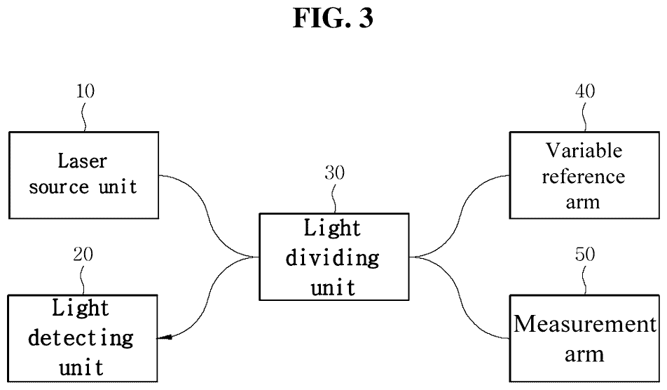

FIG. 3 is a Michelson interferometer-based system including a laser source unit 10 that emits light having a variable wavelength, a light dividing unit 30 that divides the light into a variable reference arm 40 and a measurement arm 50, a variable reference arm 40 having a structure for selecting an optical path length of a reference arm, the measurement arm 50 for propagating light and receiving light reflected from a target object, and a light detecting unit 20 detecting an optical signal generated as light passing through the variable reference arm 40 and light passing through the measurement arm 50 cause optical interference, wherein the main measurement range in which a relative maximum optical interference intensity is detected is adjusted according to active selection of an optical path length of the reference arm 40 varied at the variable reference arm 40.

The light output from the laser source unit 10 is divided and directed to a variable reference arm 40 and a measurement arm 50 at the light dividing unit 30. The light returned from the reflective variable reference arm 40 and the measurement arm 50 generates an optical interference signal while passing through the light dividing unit 30, and the corresponding optical interference signal is detected by the light detecting unit 20.

That is, after varying and propagating through selection of one of a plurality of different optical path lengths at the variable reference arm 40, light returned upon being reflected from the reference reflector 60 and light returned upon being reflected from the target object 70 at the measurement arm 50 generate the optical interference signal through a Michelson interferometer in the light dividing unit 30, the optical interference signal is detected by the light detecting unit 20, and the main measurement range in which a relative maximum optical interference intensity is detected is adjusted according to active selection of an optical path length of the reference arm varied at the variable reference arm 40.

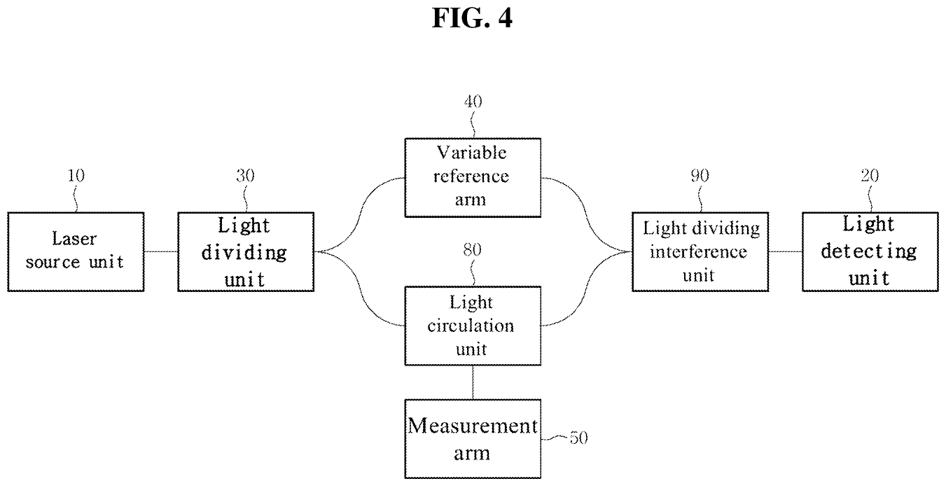

FIG. 4 is a Mach-Zehnder interferometer-based system including a laser source unit 10 emitting light having a variable wavelength, a light dividing unit 30 dividing the light into a transmissive variable reference arm 40 and an light circulation unit 80, a variable reference arm 40 having a structure for selecting an optical path length of the reference arm, a measurement arm 50 propagating the light transmitted through the light circulation unit 80, receiving the light reflected from the target object, and allowing the light to be transmitted through a light dividing interference unit 90 through the light circulation unit 80, the light dividing interference unit 90 generating an optical interference signal of light of the measurement unit 50 transmitted to the light dividing interference unit 90 through the light circulation unit 80 and light passing through the transmissive variable reference arm 40, and a light detecting unit 20 detecting an optical interference signal generated as the light passing through the variable reference arm 40 and the light passing through the measurement arm 60 causes optical interference at the light dividing interference unit 90.

The light output from the laser source unit 10 is divided and directed to the transmissive variable reference arm 40 and the light circulation unit 80 at the light dividing unit 30. The light circulation unit 80 has the measurement arm 50, and the light returned from the measurement arm 50 is transmitted to the light dividing interference unit 90 through the light circulation unit 80, and the light passing through the transmissive variable reference arm 40 also meets at the light dividing interference unit 90 to generate an optical interference signal. The corresponding optical interference signal is detected by the light detecting unit 20.

That is, after varying and propagating through selection of one of a plurality of different optical path lengths at the variable reference arm 40, light transmitted and moving to the light dividing interference unit 90 at a different position from the light dividing unit 30 and light transmitting the light dividing unit 30 and the light circulation unit 80 to move to the measurement arm 40 and reflected from the target object 70 at the measurement arm 50 and transmitted to the light circulation unit 80 and the light dividing interference unit 90 generate an optical interference signal through the Mach-Zehnder interferometer at the light dividing interference unit 90, and the optical interference signal is detected by the light detecting unit 20, and the main measurement range in which a relative maximum optical interference intensity is detected is adjusted according to active selection of an optical path length of the reference arm varied at the variable reference arm 40.

In the optical interferometric LiDAR system to control the main measurement range using active selection of a reference optical path length according to the present disclosure having such a structure, relative distance difference information based on a time of the target object, relative direction information of the target object, or relative speed information of the target object is obtained by repeatedly comparing optical interference intensity of each of a plurality of optical signals detected by the light detecting unit according to time by adjusting the variable reference arm according to time.

Also, the main measurement range in which a relative maximum optical interference intensity is detected is adjusted according to active selection of an optical path length of the reference arm varied at the variable reference arm 40, using a method of relatively comparing a result of comparing the optical interference intensity of each of a plurality of optical signals detected by the light detecting unit 20 according to time by adjusting the variable reference arm according to time and a result of comparing optical interference intensities according to optical path lengths based on absorption loss and scattering loss occurring due to optical propagation between the measurement arm and the target object and optical reflection atmospheric environment.

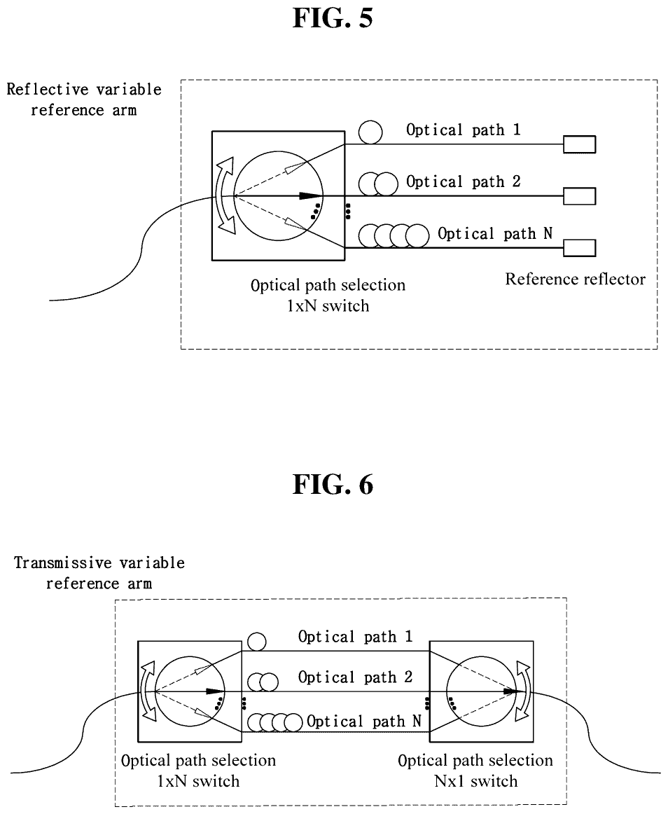

FIG. 5 shows an example of a reflective variable reference arm, and a variable operation to be reflected by a reference reflector is enabled by selecting a specific optical path among a plurality of optical paths through one 1×N switch.

Specifically, the reflective variable reference includes an optical path selection switch, a plurality of optical fibers having different optical path lengths, and a reference reflector at the end of each of the plurality of optical fibers, and the main measurement range in which a relative maximum optical interference intensity is detected is adjusted according to active selection of an optical path length of the reference arm varied at the variable reference arm, using a method of selecting a specific optical fiber as a reflective type as the optical path selection switch is reacted by a manual command, an automatic command based on position information of the target object, or an automatic command based on a distance speed information of the target object.

FIG. 6 shows an example of a transmissive variable reference arm, and a variable operation of transmitting is enabled by selecting a specific optical path among a plurality of optical paths through two 1×N switches.

Specifically, the transmissive the variable reference arm includes an optical path selection switch at an entrance, a plurality of optical fibers having different optical path lengths, and an optical path selection switch at an exit, and the main measurement range in which a relative maximum optical interference intensity is detected is adjusted according to active selection of an optical path length of the reference arm varied at the variable reference arm, using a method of selecting a specific optical fiber as a transmission type as the two optical path selection switches are reacted by a manual command, an automatic command based on position information of the target object, or an automatic command based on a distance speed information of the target object.

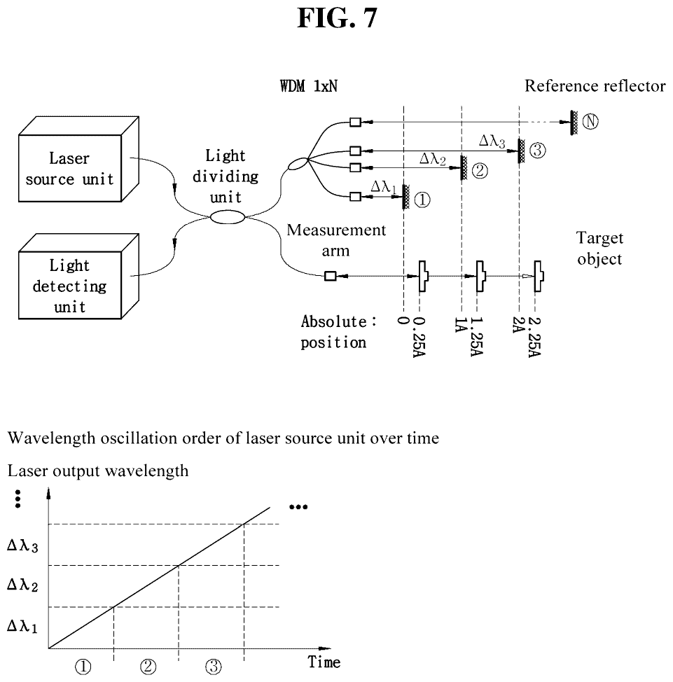

FIG. 7 shows an example in which the number of reference arms simultaneously used for measurement is increased to N according to the wavelength region by using a 1×N wavelength division multiplexer (WDM), and different optical paths are added to the divided N reference arms to form reference arms by wavelength regions having different lengths. In addition, the order of wavelength output of the laser source unit according to time is Δλ1→Δλ2→Δλ3→ . . .

Specifically, the variable reference arm using the WDM includes a wavelength division multiplexer (WDM), optical fibers having different optical path lengths by wavelength regions divided by the WDM, and a reference reflector at the end of each optical fiber, and the main measurement range in which a relative maximum optical interference intensity is detected is adjusted according to active selection of an optical path length of the reference arm corresponding to a specific wavelength region at the variable reference arm, using a method of comparing and selecting optical interference intensities of a plurality of optical signals detected according to wavelengths by the light detecting unit.

Also, as another embodiment, a variable reference arm having a structure using polarization and liquid crystal includes one or more of a partial reflector such as a fiber Bragg grating and a polarization adjusting device such as liquid crystal, and the main measurement range in which a relative maximum optical interference intensity is detected is adjusted according to active selection of an optical path length of the reference arm corresponding to a specific polarization state at the variable reference arm, using a method in which there are a plurality of different optical path lengths and light of a specific polarization state is selected to correspond to only a specific optical path length according to an operation of the polarization adjusting device.

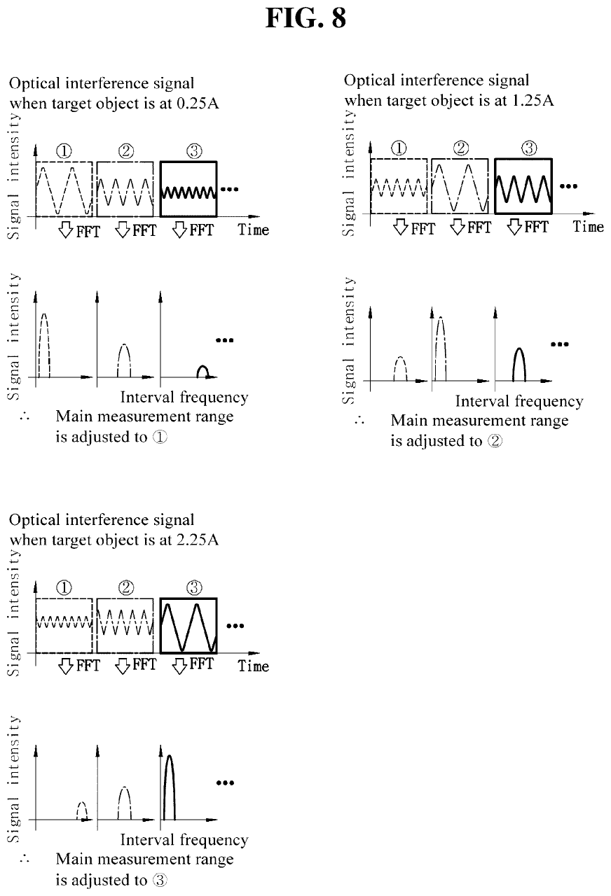

FIG. 8 shows a process in which the main measurement range is selected based on the result of the fast Fourier transform and the interference signal for each wavelength region according to the position of the target object. First, when the target object is at a 0.25 A position, the intensity of the optical signal output through the FFT at a Δλ₁ wavelength region appears the greatest. Through this, \textcircled{1} position is adjusted to the main measurement range.

When the target object is at a 1.25 A position, the intensity of the optical signal output through the FFT at a Δλ₂ wavelength region of the wavelength region appears the greatest. Through this, \textcircled{2} position is adjusted to the main measurement range.

When the target object is at a 2.25 A position, the intensity of the optical signal output through the FFT at a Δλ₃ wavelength region of the wavelength region appears the greatest. Through this, the \textcircled{3} position is adjusted to the main measurement range.

In addition, a feature of obtaining relative distance change and direction information according to time of the target object through a change in an absolute intensity according to time of the FTT intensity of an optical interference signal by wavelength regions or a change in time is included.

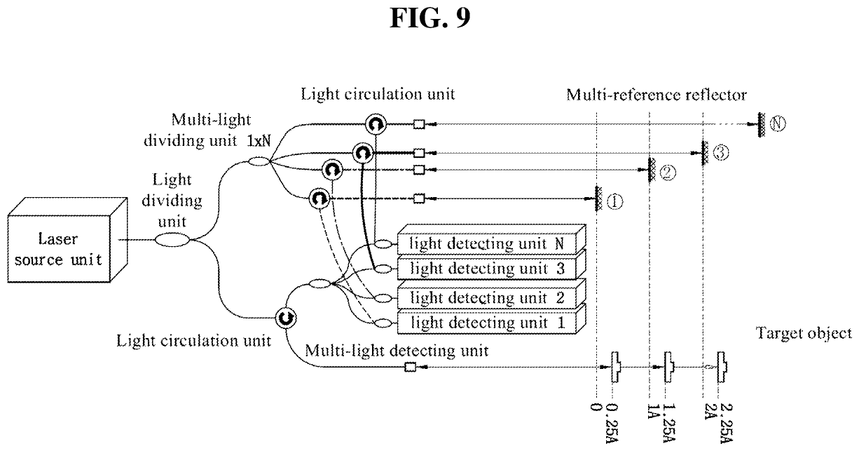

FIG. 9 is a configuration diagram illustrating an example in which the number of reference arms simultaneously used for measurement is divided by N using 1×N light dividing units, and different optical paths are added to the divided N reference arms to form reference arms having different lengths. In addition, there are light detectors respectively corresponding to the reference arms, and the main measurement range is selected through the optical interference signal detected by each light detecting unit.

Specifically, a structure in which the number of reference arms simultaneously used for measurement is divided by N using a 1×N light dividing unit includes a laser source unit configured to emit light having a variable wavelength, a light dividing unit configured to divide the light into a reference arm and a measurement arm, a multi-light dividing unit configured to divide light of the reference arm divided by the light dividing unit to a plurality of multi-reference arms, a multi-reference arm configured to allow each light divided by the multi-light dividing unit to go through different optical path lengths, a measurement arm configured to propagate light and receive light reflected from a target object, and a multi-light detecting unit configured to detect an optical signal generated as a plurality of lights passing through the light dividing unit and the multi-light dividing unit and light passing through the measurement arm cause a plurality of light interferences, wherein the main measurement range in which a relative maximum optical interference intensity is detected is adjusted according to active selection of an optical path length of the reference arm varied at the variable reference arm, using a method of selecting optical interference intensities of a plurality of optical signals detected by the multi-light detecting unit.

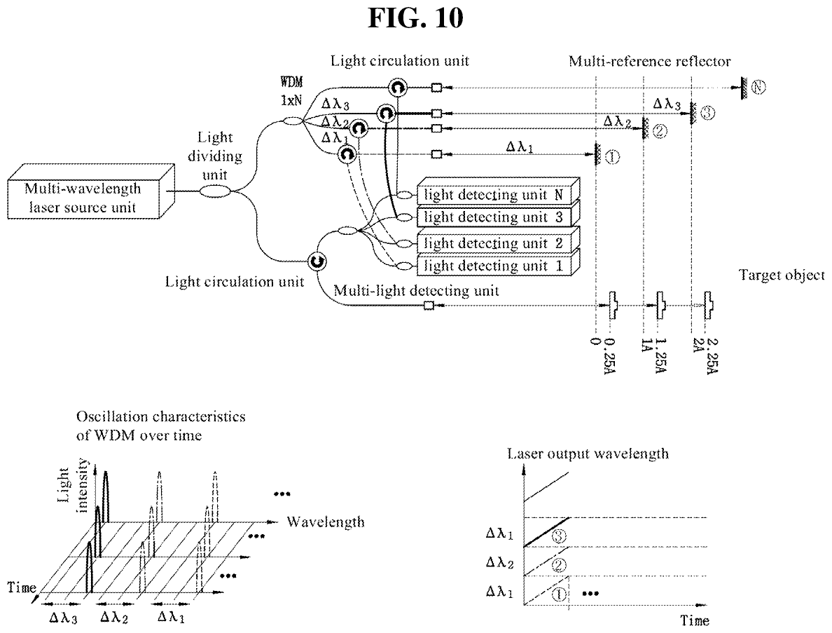

FIG. 10 is a configuration diagram illustrating an example in which the number of reference arms used simultaneously for measurement is divided by N using 1×N WDMs, and different optical paths are added to each of the N reference arms divided by wavelengths to form reference arms having different lengths by wavelengths. In addition, light detectors respectively corresponding to the reference arms for each wavelength are provided, and the main measurement range is selected through the optical interference signal detected by each light detector. In addition, output characteristics according to time output from the laser source unit are shown, and the output wavelengths according to time are varied by Δλ₁, Δλ₂, and Δλ₃, respectively.

Specifically, in a structure in which different optical paths are added to N reference arms divided by wavelength to form reference arms having different lengths for each wavelength, the laser source unit includes a multi-wavelength laser source units configured to output each wavelength varied by time. The WDM unit divide light to difference path depend on wavelength of light and each different wavelength goes through different optical path length. And, each different wavelength have different optical interference frequency and goes into each light detecting unit, and the main measurement range in which a relative maximum optical interference intensity is detected is adjusted according to active selection of an optical path length of the reference arm varied at the variable reference arm, using a method of comparing and selecting optical interference intensities of a plurality of optical signals.

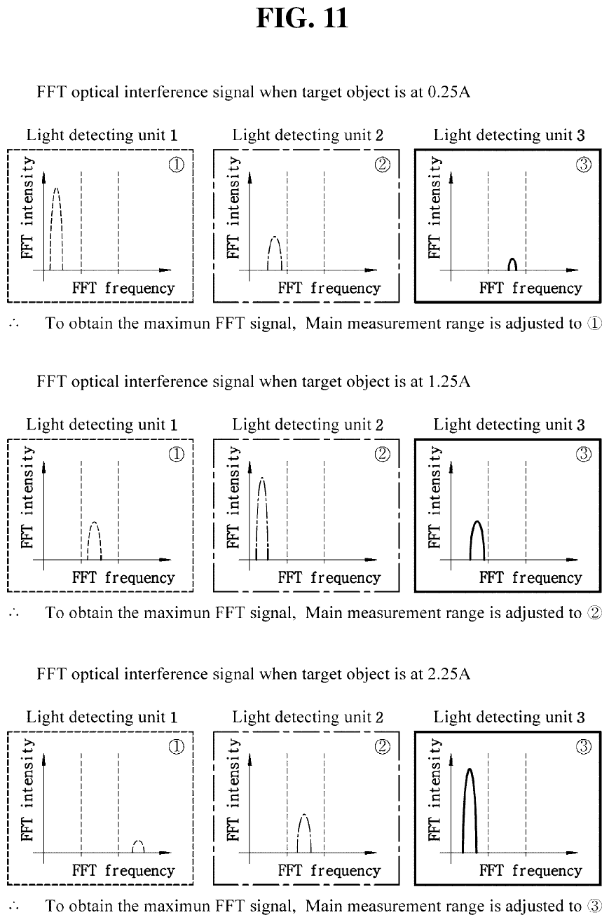

FIG. 11 shows FFT intensity over FFT frequency of interference signals according to positions of a target object, and a portion from which the strongest signal is obtained among each light detecting unit is selected as the main measurement range. When the target object is at the 0.25 A position, the intensity of a light detecting unit 1 is the strongest, and through this, position \textcircled{1} is adjusted to the main measurement range.

When the position of the target object is at 1.25 A, the intensity of a light detecting unit 2 is the strongest, and through this, position \textcircled{2} is adjusted to the main measurement range.

When the position of the target object is at 2.25 A, the intensity of a light detecting unit 3 is the strongest, and through this, position \textcircled{3} is adjusted to the main measurement range.

With the optical interferometric LiDAR system to control the main measurement range using active selection of a reference optical path length having the structure described above, the optical interference intensities of the plurality of optical signals detected by the multi-light detecting unit according to different optical path lengths are repeatedly compared according to time for selection according to a ratio, thereby obtaining relative distance difference information based on a time of the target object, relative direction information of the target object, or relative speed information of the target object.

Also, the main measurement range in which a relative maximum optical interference intensity is detected is adjusted according to active selection of an optical path length of the reference arm varied at the variable reference arm, using a method of obtaining relative speed information of the obtained target object.

Also, for selection according to loss, the main measurement range in which a relative maximum optical interference intensity is detected is adjusted according to active selection of an optical path length of the reference arm varied at the variable reference arm, using a method of relatively comparing a result of comparing the optical interference intensity of each of a plurality of optical signals detected by the multi-light detecting unit according to different optical path lengths and a result of comparing optical interference intensity according to optical path lengths based on absorption loss and scattering loss occurring due to optical propagation between the measurement arm and the target object and optical reflection atmospheric environment.

The optical interferometric LiDAR system to control the main measurement range using active selection of a reference optical path length according to the present disclosure described above, that is, in the optical interferometric LiDAR system of obtaining an optical interference signal generated due to an optical path distance difference between a distance to a target object within a measurement arm and a distance to a reference reflector within a reference arm and calculating the optical interference signal into a relative distance to measure an absolute distance of an object, the main measurement range in a target object optical path position corresponding to a reference reflector optical path distance may be actively selected by using the variable reference arm capable of actively changing the optical path length of the reference arm.

As described above, it will be understood that the present disclosure is implemented in a modified form without departing from the essential characteristics of the present disclosure.

Therefore, the specified embodiments are to be considered in an illustrative rather than a restrictive view, the scope of the present disclosure is indicated in the claims rather than the foregoing description, and all differences within the equivalent scope should be interpreted to be included in the present disclosure.

### DESCRIPTION OF REFERENCE CHARACTERS

10: laser source unit
20: light detecting unit
30: light dividing unit
40: variable reference arm
50: measurement arm
60: reference reflector
70: target object

What is claimed is:

1. An optical interferometric LiDAR system to control the main measurement range using active selection of a reference optical path length, the optical interferometric LiDAR system comprising:
a laser source unit configured to emit light having a variable wavelength;
a light dividing unit configured to divide the light into a variable reference arm and a measurement arm;
a variable reference arm having a structure for selecting an optical path length of a reference arm;
a measurement arm configured to propagate light and receive light reflected from a target object; and
a light detecting unit configured to detect an optical signal generated as light passing through the variable reference arm and light passing through the measurement arm cause optical interference,
wherein the main measurement range in which a relative maximum optical interference intensity is detected is adjusted according to active selection of an optical path length of the reference arm varied at the variable reference arm.

2. The optical interferometric LiDAR system of claim 1, wherein relative distance difference information based on a time of the target object, relative direction information of the target object, or relative speed information of the target object is obtained by repeatedly comparing optical interference intensity of each of a plurality of optical signals detected by the light detecting unit according to time by adjusting the variable reference arm according to time.

3. The optical interferometric LiDAR system of claim 2, wherein the main measurement range in which a relative maximum optical interference intensity is detected is adjusted according to active selection of an optical path length of the reference arm varied at the variable reference arm, using a method of obtaining relative speed information of the obtained target object.

4. The optical interferometric LiDAR system of claim 1, wherein the main measurement range in which a relative maximum optical interference intensity is detected is adjusted according to active selection of an optical path length of the reference arm varied at the variable reference arm, using a method of relatively comparing a result of comparing the optical interference intensity of each of a plurality of optical signals detected by the light detecting unit according to time by adjusting the variable reference arm according to time and a result of comparing optical interference intensities according to optical path lengths based on absorption loss and scattering loss occurring due to optical propagation between the measurement arm and the target object and optical reflection atmospheric environment.

5. The optical interferometric LiDAR system of claim 1, wherein the main measurement range in which a relative maximum optical interference intensity is detected is adjusted according to active selection of an optical path length of the reference arm varied at the variable reference arm, as an optical interference signal generated through a Michelson interferometer is detected in the light dividing unit based on light varied and propagated through selection of one of a plurality of different optical path lengths at the variable reference arm and then returned after being reflected by a reference reflector and light returned after being reflected from the target object at the measurement arm.

6. The optical interferometric LiDAR system of claim 1, wherein a Mach-Zehnder interferometer including a light dividing interference unit is provided, and the main measurement range in which a relative maximum optical interference intensity is detected is adjusted according to active selection of an optical path length of the reference arm varied at the variable reference arm, as an optical interference signal generated through the Mach-Zehnder interferometer including the light dividing interference unit is detected in the light detecting unit based on light varied and propagated through selection of one of a plurality of different optical path lengths at the variable reference arm and then moving after being transmitted to the light dividing interference unit in a position different from the light dividing unit and light transmitted through the light dividing unit and a light circulation unit to move to the measurement arm and moving after being reflected from the target object at the measurement arm and transmitted to the light circulation unit and the light dividing interference unit.

7. The optical interferometric LiDAR system of claim 1, wherein the variable reference arm includes an optical path selection switch, a plurality of optical fibers having different optical path lengths, and a reference reflector at the end of each of the plurality of optical fibers, and the main measurement range in which a relative maximum optical interference intensity is detected is adjusted according to active selection of an optical path length of the reference arm varied at the variable reference arm, using a method of selecting a specific optical fiber as a reflective type as the optical path selection switch is reacted by a manual command, an automatic command based on position information of the target object, or an automatic command based on a distance speed information of the target object.

8. The optical interferometric LiDAR system of claim 1, wherein the variable reference arm includes an optical path selection switch at an entrance, a plurality of optical fibers having different optical path lengths, and an optical path selection switch at an exit, and the main measurement range in which a relative maximum optical interference intensity is detected is adjusted according to active selection of an optical path length of the reference arm varied at the variable reference arm, using a method of selecting a specific optical fiber as a transmission type as the two optical path selection switches are reacted by a manual command, an automatic command based on position information of the target object, or an automatic command based on a distance speed information of the target object.

9. The optical interferometric LiDAR system of claim 1, wherein the variable reference arm includes a wavelength division multiplexer (WDM), optical fibers having different optical path lengths by wavelength regions divided by the WDM, and a reference reflector at the end of each optical fiber, and the main measurement range in which a relative maximum optical interference intensity is detected is adjusted according to active selection of an optical path length of the reference arm corresponding to a specific wavelength region at the variable reference arm, using a method of comparing and selecting optical interference intensities of a plurality of optical signals detected according to wavelengths by the light detecting unit.

10. The optical interferometric LiDAR system of claim 1, wherein the variable reference arm includes one or more of a partial reflector having a fiber Bragg grating structure and a liquid crystal polarization adjusting device, and the main measurement range in which a relative maximum optical interference intensity is detected is adjusted according to active selection of an optical path length of the reference arm corresponding to a specific polarization state at the variable reference arm, using a method in which there are a plurality of different optical path lengths and light of a specific polarization state is selected to correspond to only a specific optical path length according to an operation of the polarization adjusting device.

11. An optical interferometric LiDAR system to control the main measurement range using active selection of a reference optical path length, the optical interferometric LiDAR system comprising:
a laser source unit configured to emit light having a variable wavelength;
a light dividing unit configured to divide the light into a reference arm and a measurement arm;
a multi-light dividing unit configured to divide light of the reference arm divided by the light dividing unit to a plurality of multi-reference arms;
a multi-reference arm configured to allow each light divided by the multi-light dividing unit to go through different optical path lengths;
a measurement arm configured to propagate light and receive light reflected from a target object; and
a multi-light detecting unit configured to detect an optical signal generated as a plurality of lights passing through the light dividing unit and the multi-light dividing unit and light passing through the measurement arm cause a plurality of light interferences,
wherein the main measurement range in which a relative maximum optical interference intensity is detected is adjusted according to active selection of an optical path length of the reference arm varied at the variable reference arm, using a method of selecting optical interference intensities of a plurality of optical signals detected by the multi-light detecting unit.

12. The optical interferometric LiDAR system of claim 11, wherein the laser source unit includes a multi-wavelength laser light source units configured to emit light varied by multiple output wavelengths simultaneously, the multi-wavelength dividing unit divide each path which have different optical path length according to wavelength region.
And the main measurement range in which a relative maximum optical interference intensity is detected is adjusted according to active selection of an optical path length of the reference arm varied at the variable reference arm, using a method of comparing and selecting optical interference intensities of a plurality of optical signals obtained by simultaneously detecting a plurality of lights through different optical path lengths by the wavelength regions by the multi-light detecting unit.

13. The optical interferometric LiDAR system of claim 11, wherein relative distance difference information based on a time of the target object, relative direction information of the target object, or relative speed information of the target object is obtained by repeatedly comparing optical interference intensity of each of a plurality of optical signals detected by the multi-light detecting unit according to different optical path lengths.

14. The optical interferometric LiDAR system of claim 13, wherein the main measurement range in which a relative maximum optical interference intensity is detected is adjusted according to active selection of an optical path length of the reference arm varied at the variable reference arm, using a method of obtaining relative speed information of the obtained target object.

15. The optical interferometric LiDAR system of claim 11, wherein the main measurement range in which a relative maximum optical interference intensity is detected is adjusted according to active selection of an optical path length of the reference arm varied at the variable reference arm, using a method of relatively comparing a result of comparing the optical interference intensity of each of a plurality of optical signals detected by the multi-light detecting unit according to different optical path lengths and a result of comparing optical interference intensities according to optical path lengths based on absorption loss and scattering loss occurring due to optical propagation between the measurement arm and the target object and optical reflection atmospheric environment.
